(19) United States
(12) Patent Application Publication
(10) Pub. No.: US 2022/0111628 A1
(43) Pub. Date: Apr. 14, 2022

(54) A LITHOGRAPHIC PRINTING PLATE PRECURSOR

(71) Applicant: AGFA NV, Mortsel (BE)

(72) Inventors: Elke Dom, Mortsel (BE); Karen Demmers, Mortsel (BE); Johan Loccufier, Mortsel (BE)

(73) Assignee: AGFA NV, Mortsel (BE)

(21) Appl. No.: 17/425,131

(22) PCT Filed: Jan. 20, 2020
(86) PCT No.: PCT/EP2020/051216

§ 371 Date: Jul. 22, 2021

(30) Foreign Application Priority Data
Jan. 23, 2019 (EP) 19153178.9

(51) Int. Cl. B41C 1/10

(52) U.S. Cl. CPC B41C 1/1016; B41C 2210/04; B41C 2210/06; B41C 2210/08

(57) ABSTRACT

A lithographic printing plate precursor is disclosed including a support and a coating including a polymerisable compound, an optionally substituted trihaloalkyl sulfone initiator, a leuco dye and a specific infrared absorbing compound including a six membered ring in the central position.

### TECHNICAL FIELD

The invention relates to a novel lithographic printing plate precursor.

### BACKGROUND ART

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Lithographic printing masters are generally obtained by the image-wise exposure and processing of a radiation sensitive layer on a lithographic support. Imaging and processing renders the so-called lithographic printing plate precursor into a printing plate or master. Image-wise exposure of the radiation sensitive coating to heat or light, typically by means of a digitally modulated exposure device such as a laser, triggers a (physico-)chemical process, such as ablation, polymerization, insolubilization by cross-linking of a polymer or by particle coagulation of a thermoplastic polymer latex, solubilization by the destruction of intermolecular interactions or by increasing the penetrability of a development barrier layer. Although some plate precursors are capable of producing a lithographic image immediately after exposure, the most popular lithographic plate precursors require wet processing since the exposure produces a difference in solubility or difference in rate of dissolution in a developer between the exposed and the non-exposed areas of the coating. In positive working lithographic plate precursors, the exposed areas of the coating dissolve in the developer while the non-exposed areas remain resistant to the developer. In negative working lithographic plate precursors, the non-exposed areas of the coating dissolve in the developer while the exposed areas remain resistant to the developer. Most lithographic plate precursors contain a hydrophobic coating on a hydrophilic support, so that the areas which remain resistant to the developer define the ink-accepting, hence printing areas of the plate while the hydrophilic support is revealed by the dissolution of the coating in the developer at the non-printing areas.

Photopolymer printing plates rely on a working-mechanism whereby the coating—which typically includes free radically polymerisable compounds—hardens upon exposure. “Hardens” means that the coating becomes insoluble or non-dispersible in the developing solution and may be achieved through polymerization and/or crosslinking of the photosensitive coating upon exposure to light. Photopolymer plate precursors can be sensitized to blue, green or red light i.e. wavelengths ranging between 450 and 750 nm, to violet light i.e. wavelengths ranging between 350 and 450 nm or to infrared light i.e. wavelengths ranging between 750 and 1500 nm. Optionally, the exposure step is followed by a heating step to enhance or to speed-up the polymerization and/or crosslinking reaction.

In general, a toplayer or protective overcoat layer over the imageable layer is required to act as an oxygen barrier to provide the desired sensitivity to the plate. A toplayer typically includes water-soluble or water-swellable polymers such as for example polyvinylalcohol. Besides acting as barrier for oxygen, the toplayer should best be easily removable during processing and be sufficiently transparent for actinic radiation, e.g. from 300 to 450 nm or from 450 to 750 nm or from 750 to 1500 nm.

The classical workflow of photopolymer plates involves first an exposure step of the photopolymer printing plate precursor in a violet or infrared platesetter, followed by an optional pre-heat step, a wash step of the protective overcoat layer, an alkaline developing step, and a rinse and gum step. Over the past years, there is a clear evolution in the direction of a simplified workflow where the pre-heat step and/or wash step are eliminated and where the processing and gumming step are carried out in one single step or where processing is carried out with a neutral gum and then gummed in a second step. Alternatively, on-press processing wherein the plate is mounted on the press and the coating layer is developed by interaction with the fountain and ink that are supplied to the plate during the press run, has become very popular. During the first runs of the press, the non-image areas are removed from the support and thereby define the non-printing areas of the plate.

In order to be able to evaluate the lithographic printing plates for image quality, such as for example image resolution and detail rendering (usually measured with an optical densitometer) before mounting them on the press, the lithographic printing plate precursors often contain a colorant such as a dye or a pigment in the coating. Such colorants provide, after processing, a contrast between the image areas containing the colorant and the hydrophilic support where the coating has been removed which enables the end-user to evaluate the image quality and/or to establish whether or not the precursor has been exposed to light. Furthermore, besides allowing for the evaluation of the image quality, a high contrast between the image and the hydrophilic support is required in order to obtain a good image registration (alignment) of the different printing plates in multi-colour printing in order to ensure image sharpness (resolution) and a correct rendering of the colours in the images present.

However, for photopolymer lithographic printing plates which are processed on-press and thus development of the plate is not carried out before mounting the plate on the press, a previous inspection and discrimination of the plate including colorants is not possible. A solution has been provided in the art by including components to the coating which are able to form upon exposure a so-called “print-out image”, i.e. an image which is visible before processing. In these materials however, often the photo-initiating system is a reacting component, which induces formation of the print-out image upon exposure, and therefore the lithographic differentiation may be reduced.

Formation of a print-out image for violet sensitized photopolymer systems have been disclosed in for example U.S. Pat. Nos. 3,359,109; 3,042,515; 4,258,123; 4,139,390; 5,141,839; 5,141,842; 4,232,106; 4,425,424; 5,030,548; 4,598,036; EP 434 968; WO 96/35143 and US 2003/68575.

The formation of a print-out image is also known for heat-sensitive photopolymer lithographic printing plates. Such plates are usually image-wise exposed by an IR-laser and often comprise, beside an IR dye as a light-to-heat conversion compound, also a dye which absorbs in the visible light wavelength range and changes colour upon heating. This colour change can be obtained for example with a heat-decomposable dye which bleaches upon heating such as disclosed in EP 897 134, EP 925 916, WO 96/35143, EP 1 300 241. Alternatively, this heat-induced colour change can be the result of a shift of the absorption maximum of a visible dye as disclosed in EP 1 502 736 and EP 419 095.

Thermochromic dye technology involves the design of an IR dye containing a thermocleavable group whereby a colour shift is obtained upon exposure with heat and/or light. This technology offers lithographic contrast which is enhanced by increasing either the thermochromic dye concentration or the exposure energy. However, this technology is especially suitable for thermofuse plates—i.e. plates including an image-recording layer that works by heat-induced particle coalescence of a thermoplastic polymer latex,—and does not work well in photopolymer coatings. Indeed, only an acceptable contrast in photopolymer coatings is feasible when exposed by very high laser energy and/or when a substantially high concentration of the thermochromic dye is incorporated in the coating.

The heat-sensitive lithographic printing plate precursors disclosed in EP 925 916 include an IR dye which, upon IR-radiation, converts the IR-radiation into heat and at the same time changes in colour. In these prior art materials, the IR dyes exhibit, beside strong absorption in the IR wavelength range, also a side-absorption in the visible wavelength range. Due to IR-exposure, the IR dye decomposes and a print-out image is build-up by the reduction of this side-absorption in the visible wavelength range.

Unpublished patent application EP 17182246 discloses a printing plate material including a coating comprising a trihaloalkyl sulfone initiator and an infrared absorbing agent, which forms a print-out image without the presence of any colorant.

Contrast-providing colorants obtained from the so-called leuco dyes that switch colour upon changes in pH, temperature, UV etc, have been widely used in the art. The leuco dye technology involves a switch between two chemical forms whereby one is colourless. If the colour switch is caused by for example pH or temperature, the transformation is reversible. Irreversible switches are based on redox reactions.

The use of contrast-providing colorants obtained from leuco dyes that become coloured in the presence of a thermal acid generator, is described for example, in U.S. Pat. Nos. 7,402,374; 7,425,406 and 7,462,440. The colouring of the printing areas is initiated by image-wise exposure whereby the image areas are visualized before performing development of the plate precursor.

A problem associated with the prior art materials is that often the obtained print-out images after exposure are characterized by only a low contrast between the exposed and the non-exposed areas, high exposure energies are required to generate a contrast and/or high levels of leuco dyes are required. Moreover, often the obtained contrast fades away in time when the exposed plates are not immediately used for the printing job. In other words, the obtained contrast often decreases during handling and/or storage in for example office light.

In conclusion, there is still a need for photopolymer printing plate coating formulations which offer an improved contrast between the image areas and background areas and which are preferably designed for direct on-press development, without causing the problems as discussed above.

### SUMMARY OF INVENTION

It is therefore an object of the present invention to provide a printing plate based on photopolymerisation which offers an excellent visual contrast upon imaging—even before processing—which remains stable or even enhances after handling and/or storage in office light.

This object is realised by the printing plate precursor defined in claim 1 with preferred embodiments defined in the dependent claims. The invention has the specific feature that the printing plate precursor includes a coating comprising a trihaloalkyl sulfone initiator, a leuco dye and an infrared absorbing agent having the following structure:

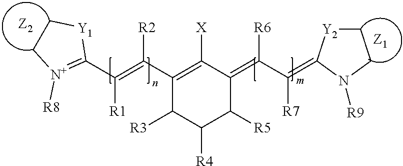

wherein the definitions of the substituents are defined below.

It has surprisingly been observed that the print-out image that is formed upon heat and/or light exposure of the coating according to the present invention, remains stable or is even boosted after storage in for example office light conditions.

It is a further object of the present invention to provide a method for making a lithographic printing plate comprising the steps of:
image-wise exposing the printing plate precursor including the coating as defined above to heat and/or IR radiation whereby a lithographic image consisting of image areas and non-image areas is formed and whereby a colour change in the image areas is induced;
developing the exposed precursor.

The development is preferably carried out by treating the precursor with a gum solution, however more preferably by mounting the precursor on a plate cylinder of a lithographic printing press and rotating the plate cylinder while feeding dampening liquid and/or ink to the precursor.

Other features, elements, steps, characteristics and advantages of the present invention will become more apparent from the following detailed description of preferred embodiments of the present invention. Specific embodiments of the invention are also defined in the dependent claims.

### DESCRIPTION OF EMBODIMENTS

The lithographic printing plate precursor of the current invention provides a colour change immediately after the exposure step and thus a print-out image is formed which makes the plate specifically suited for development on-press i.e. development by mounting the precursor on a plate cylinder of a lithographic printing press and rotating the plate cylinder while feeding dampening liquid and/or ink to the coating. Moreover, the exposure energy required to obtain a print-out image is low compared to the systems provided in the art, for example below 150 mJ/m², even far below 120 mJ/m²; a clear print-out image is already obtained at energy levels of about 80 to 100 mJ/m².

The print-out image is visible due to the contrast of the image which is defined as the colour difference between the exposed areas and the non-exposed areas. This contrast is preferably as high as possible and enables the end-user to establish immediately after imaging whether or not the precursor has already been exposed to heat and/or light, to distinguish the different colour selections and to inspect the quality of the image on the plate precursor. According to the current invention, it has been observed that the print-out image remains stable or even improves when the plate is not immediately used for printing but stored in for example office light conditions.

The colour difference between the exposed and non-exposed areas of the coating calculated from the L*a*b* values of the exposed areas of the image areas (exposed areas) of the coating and the L*a*b* values of non-image areas (non-exposed areas) of the coating, is denoted as ΔE. ΔE is the CIE 1976 colour distance Delta E that is defined by the pair wise Euclidean distance of the CIE L*a*b* colour coordinates. CIE L*a*b* colour coordinates are obtained from reflection measurement in 45/0 geometry (non-polarized), using CIE 2° observer and D50 as illuminant. More details are described in CIE S 014-4/E: 2007 Colourimetry—Part 4: CIE 1976 L*a*b* Colour Spaces and CIE publications and CIE S 014-1/E:2006, CIE Standard Colourimetric Observers.

The CIE 1976 colour coordinates L*, a* and b* discussed herein are part of the well-known CIE (Commission Internationale de l'Eclairage) system of tristimulus colour coordinates, which also includes the additional chroma value C* defined as C*=[(a)²+(b)²]¹′². The CIE 1976 colour system is described in e.g. “Colorimetry, CIE 116-1995: Industrial Colour Difference Evaluation”, or in “Measuring Colour” by R.W.G. Hunt, second edition, edited in 1992 by Ellis Horwood Limited, England.

CIE L*a*b* values discussed and reported herein have been measured following the ASTM E308-85 method.

### Definitions

The term hydrocarbon group herein represents an optionally substituted aliphatic or aromatic hydrocarbon group. An optionally substituted aliphatic hydrocarbon group preferably represents an alkyl, cycloalkyl, alkenyl, cyclo alkenyl or alkynyl group; suitable groups thereof are described below. An optionally substituted aromatic hydrocarbon group preferably represents a hetero(aryl) group; suitable hetero(aryl) groups—i.e. suitable aryl or heteroaryl groups—are described below.

The term “alkyl” herein means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc. Examples of suitable alkyl groups are methyl, ethyl, n-propyl, isopropyl, n-butyl, 1-isobutyl, 2-isobutyl and tertiary-butyl, n-pentyl, n-hexyl, chloromethyl, trichloromethyl, iso-propyl, iso-butyl, iso-pentyl, neo-pentyl, 1-methylbutyl and iso-hexyl, 1,1-dimethyl-propyl, 2,2-dimethyipropyl and 2-methyl-butyl, cyclopropyl, cyclobutyl, cyclopentyl, cyclohexyl and methylcyclohexyl groups. Preferably, the alkyl group is a C₁ to C₆-alkyl group.

A suitable alkenyl group is preferably a C₂ to C₆-alkenyl group such as an ethenyl, n-propenyl, n-butenyl, n-pentenyl, n-hexenyl, iso-propenyl, iso-butenyl, iso-pentenyl, neo-pentenyl, 1-methylbutenyl, iso-hexenyl, cyclopentenyl, cyclohexenyl and methylcyclohexenyl group.

A suitable alkynyl group is preferably a C₂ to C₆-alkynyl group; a suitable aralkyl group is preferably a phenyl group or naphthyl group including one, two, three or more C₁ to C₆-alkyl groups;

A suitable alkaryl group is preferably a C₁ to C₆-alkyl group including an aryl group, preferably a phenyl group or naphthyl group.

A cyclic group or cyclic structure includes at least one ring structure and may be a monocyclic- or polycyclic group, meaning one or more rings fused together.

Examples of suitable aryl groups may be represented by for example an optionally substituted phenyl, benzyl, tolyl or an ortho- meta- or para-xylyl group, an optionally substituted naphtyl, anthracenyl, phenanthrenyl, and/or combinations thereof. The heteroaryl group is preferably a monocyclic or polycyclic aromatic ring comprising carbon atoms and one or more heteroatoms in the ring structure, preferably, 1 to 4 heteroatoms, independently selected from nitrogen, oxygen, selenium and sulphur. Preferred examples thereof include an optionally substituted furyl, pyridinyl, pyrimidyl, pyrazoyl, imidazoyl, oxazoyl, isoxazoyl, thienyl, tetrazoyl, thiazoyl, (1,2,3)triazoyl, (1,2,4)triazoyl, thiadiazoyl, thiofenyl group and/or combinations thereof.

Examples of an aralkyl group is preferably a phenyl or naphthyl group including one, two, three or more C₁ to C₆-alkyl groups.

Examples of an alkaryl group is preferably a C₇ to C₂₀-alkyl group including a phenyl group or naphthyl group.

Halogens are selected from fluorine, chlorine, bromine or iodine.

Suitable polyalkylene-oxide groups preferably comprise a plurality of alkylene-oxide recurring units of the formula —CnH2n-O— wherein n is preferably an integer in the range 2 to 5. Preferred alkylene-oxide recurring units are typically ethylene oxide, propylene oxide or mixtures thereof. The moiety —CnH2n- may include straight or branched chains and may also be substituted. The number of the recurring units in the polyalkylene-oxide group preferably range between 2 and 10 units, more preferably between 2 and 5 units, and preferably less than 100, more preferably less than 60.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

The optional substituents are preferably selected from hydroxy, —F, —Cl, —Br, —I, —OH, —SH, —CN, —NO₂, an alkyl group such as a methyl or ethyl group, an alkoxy group such as a methoxy or an ethoxy group, an aryloxy group, a carboxylic acid group or an alkyl ester thereof, a sulphonic acid group or an alkyl ester thereof, a phosphonic acid group or an alkyl ester thereof, a phosphoric acid group or an an ester such as an alkyl ester such as methyl ester or ethyl ester, a thioalkyl group, a thioaryl group, thioheteroaryl, —SH, a thioether such as a thioalkyl or thioaryl, ketone, aldehyde, sulfoxide, sulfone, sulfonate ester, sulphonamide, an amino, ethenyl, alkenyl, alkynyl, cycloalkyl, alkaryl, aralkyl, aryl, heteroaryl or heteroalicyclic group and/or combinations thereof.

The Initiator

The initiator used in the current invention is an optionally substituted trihaloalkyl sulfone compound, also referred to herein as TBM-initiator. The TBM-initiator is a compound capable of generating free radicals upon exposure, optionally in the presence of a sensitizer. Halo preferably independently represents fluoro, bromo, chloro or iodo and sulfone is a chemical compound containing a sulfonyl functional group attached to two carbon atoms.

Preferably, the TBM-initiator is an optionally substituted trihaloalkyl aryl or heteroaryl sulfone compound. The optionally substituted aryl is preferably an optionally substituted phenyl, benzyl, tolyl or an ortho- meta- or para-xylyl, naphtyl, anthracenyl, phenanthrenyl, and/or combinations thereof. The heteroaryl group is preferably a monocyclic or polycyclic aromatic ring comprising carbon atoms and one or more heteroatoms in the ring structure, preferably, 1 to 4 heteroatoms, independently selected from nitrogen, oxygen, selenium and sulphur. Preferred examples thereof include an optionally substituted furyl, pyridinyl, pyrimidyl, pyrazoyl, imidazoyl, oxazoyl, isoxazoyl, thienyl, tetrazoyl, thiazoyl, (1,2,3)triazoyl, (1,2,4)triazoyl, thiadiazoyl, thiofenyl group and/or combinations thereof.and the optionally substituted heteroaryl is preferably a five- or six-membered ring substituted by one, two or three oxygen atoms, nitrogen atoms, sulphur atoms, selenium atoms or combinations thereof. Examples thereof include furan, thiophene, pyrrole, pyrazole, imidazole, 1,2,3-triazole, 1,2,4-triazole, tetrazole, oxazole, isoxazole, thiazole, isothiazole, thiadiazole, oxadiazole, pyridine, pyridazine, pyrimidine, pyrazine, 1,3,5-triazine, 1,2,4-triazine or 1,2,3-triazine, benzofuran, benzothiophene, indole, indazole, benzoxazole, quinoline, quinazoline, benzimidazole or benztriazole.

Preferably the TBM-initiator is an optionally substituted trihalomethyl aryl sulfone; more preferably a tribromomethyl aryl sulfone, most preferably the TBM-initiator is an optionally substituted tribromomethyl phenyl sulfone.

The amount of the TBM-initiator typically ranges from 0.1 to 30% by weight, preferably from 0.5 to 10% by weight, most preferably from 2 to 7% by weight relative to the total weight of the non-volatile components of the photopolymerisable composition.

The Infrared Absorbing Compound

The IR absorbing compound present in the coating of the current invention
also referred to herein as infrared absorbing dye or IR dye—is represented by Formula I:

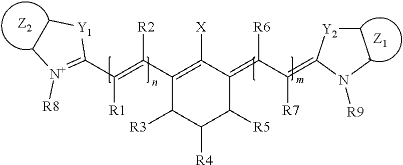

wherein,

R1, R2, R6, R7 independently represent hydrogen or an optionally substituted hydrocarbon group;

R3, R4 and R5 each independently represent hydrogen, an optionally substituted hydrocarbon group, a halogen atom, an optionally substituted alkoxy group, an optionally substituted aryloxy group, an amino group, a carbonyl containing group, or a silyl group such as for example trimethylsilyl;

X represents hydrogen, a halogen atom, —SR11, —OR12, —NR13(LₐR14), an optionally substituted hydrocarbon group, preferably an optionally substituted (hetero)aryl group;

L represents a divalent linking group;

a represents 0 or 1;

R11 and R12 independently represent an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

Y1 and Y2 each independently represents —N(R10)-, —S—, —O—, —CH═CH—, or a dialkylmethylene group;

R8, R9 and R10 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;

Z1 and Z2 each independently represent an optionally substituted aryl or heteroaryl group;

n and m independently represent an integer equal to zero, 1 or greater; preferably an integer equal to 0, 1, 2, 3, 4 or 5; most preferably equal to 1; and

optionally one or more counter ions in order to obtain an electrically neutral compound.

Preferably, the IR absorbing compound is represented by Formula I wherein

R1 to R10, Y1 and Y2, Z1 and Z2 and n and m are as defined above for Formula I; and

X represents hydrogen, a halogen atom, —SR11, —NR13(LₐR14), an optionally substituted hydrocarbon group, preferably an optionally substituted (hetero)aryl group, more preferably an optionally substituted pyridine represented by Formula A:

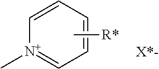

wherein X*— represents a counter ion to neutralize electric charge; and R* represents hydrogen, an alkyl group, an alkoxy group, an aryl group, an amino group or a halogen atom;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring; L represents a divalent linking group;

a represents 0 or 1;

and optionally one or more counter ions in order to obtain an electrically neutral compound.

More preferably, the IR absorbing compound is represented by Formula I wherein

R1 to R10, Y1 and Y2, Z1 and Z2 are as defined above for Formula I; n and m are equal to 1 and

X represents hydrogen, —SR11, —NR13(LₐR14), an optionally substituted hydrocarbon group, preferably an optionally substituted (hetero)aryl group, more preferably an optionally substituted pyridine represented by Formula A;

R11 represents an optionally substituted hydrocarbon group; preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

L represents a divalent linking group;

a represents 0 or 1; and

optionally one or more counter ions in order to obtain an electrically neutral compound.

Most preferably, the IR absorbing compound is represented by Formula I wherein

R1 to R10, Y1 and Y2, Z1 and Z2 are as defined above for Formula I;

n and m are equal 1 and

X represents —SR11 or —NR13(LₐR14);

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

L represents a divalent linking group;

a represents 0 or 1; and

optionally one or more counter ions in order to obtain an electrically neutral compound.

In a preferred embodiment, the IR absorbing compound is represented by Formula II:

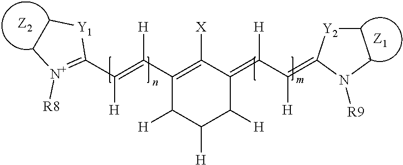

wherein

X represents hydrogen, a halogen atom, —SR11, —OR12, —NR13(LₐR14), an optionally substituted hydrocarbon group, preferably an optionally substituted (hetero)aryl group;

R11 and R12 independently represent an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

Y1 and Y2 each independently represents —N(R10)-, —S—, —O—, —CH═CH—, or a dialkylmethylene group,

R8, R9 and R10 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;

Z1 and Z2 each independently represent an optionally substituted aryl or heteroaryl group;

n and m independently represent an integer equal to zero, 1 or greater; preferably an integer equal to 0, 1, 2, 3, 4 or 5; most preferably equal to 1;

L represents a divalent linking group;

a represents 0 or 1; and

optionally one or more counter ions in order to obtain an electrically neutral compound.

Preferably, the IR absorbing compound is represented by Formula II wherein

R8 to R10, Y1 and Y2, Z1 and Z2 and n and m are as defined above for Formula II; and

X represents hydrogen, a halogen atom, —SR11, —NR13(LₐR14), an optionally substituted hydrocarbon group, preferably an optionally substituted (hetero)aryl group, more preferably an optionally substituted pyridine represented by Formula A;

R11 and R12 independently represent an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

L represents a divalent linking group;

a represents 0 or 1; and

and optionally one or more counter ions in order to obtain an electrically neutral compound.

More preferably, the IR absorbing compound is represented by Formula II wherein

R8 to R10, Y1 and Y2 and Z1 and Z2 are as defined above for Formula II; X represents hydrogen, —SR11, —NR13(LₐR14); an optionally substituted hydrocarbon group, preferably an optionally substituted (hetero)aryl group, more preferably an optionally substituted pyridine represented by Formula A;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

n and m are equal to 1;

L represents a divalent linking group;

a represents 0 or 1; and

and optionally one or more counter ions in order to obtain an electrically neutral compound.

Most preferably, the IR absorbing compound is represented by Formula II wherein

R8 to R10, Y1 and Y2 and Z1 and Z2 are as defined above for Formula II;

X represents —SR11 or —NR13(LₐR14);

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

n and m are equal to 1;

L represents a divalent linking group;

a represents 0 or 1; and

and optionally one or more counter ions in order to obtain an electrically neutral compound.

In a more preferred embodiment, the IR absorbing compound is represented by Formula III or Formula IV

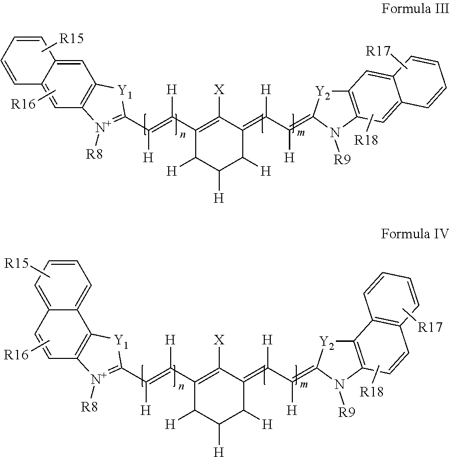

wherein

X represents hydrogen, a halogen atom, —SR11, —OR12, —NR13(LₐR14), an optionally substituted hydrocarbon group or an optionally substituted (hetero)aryl group;

R11 and R12 independently represent an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

Y1 and Y2 each independently represents —N(R10)-, S, O, —CH═CH—, or a dialkylmethylene group,

R8, R9 and R10 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;

n and m independently represent an integer equal to zero, 1 or greater; preferably an integer equal to 0, 1, 2, 3, 4 or 5; most preferably equal to 1; R15, R16, R17 and R18 independently represent hydrogen, an amine group, a halogen atom, an alkoxy group or a nitrile;

L represents a divalent linking group;

a represents 0 or 1; and

and optionally one or more counter ions in order to obtain an electrically neutral compound.

Preferably, the IR absorbing compound is represented by Formula III or Formula IV wherein:

R8 to R10, Y1, Y2 and R15 to R18, n and m are as defined above for Formula III or Formula IV;

X represents hydrogen, a halogen atom, —SR11, —NR13(LₐR14), an optionally substituted hydrocarbon group, preferably an optionally substituted (hetero)aryl group, more preferably an optionally substituted pyridine represented by Formula A;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring; L represents a divalent linking group;

a represents 0 or 1; and

and optionally one or more counter ions in order to obtain an electrically neutral compound.

More preferably, the IR absorbing compound is represented by Formula III or Formula IV wherein:

R8 to R10, Y1, Y2 and R15 to R18 are as defined above for Formula III or Formula IV;

X represents hydrogen, —SR11, —NR13(LaR14), an optionally substituted hydrocarbon group, preferably an optionally substituted (hetero)aryl group;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

n and m represent 1;

L represents a divalent linking group;

a represents 0 or 1; and

and optionally one or more counter ions in order to obtain an electrically neutral compound.

Most preferably, the IR absorbing compound is represented by Formula III or Formula IV wherein:

R8 to R10, Y1, Y2 and R15 to R18 are as defined above for Formula III or Formula IV;

X represents —SR11 or —NR13(LₐR14); R11 represents an optionally substituted hydrocarbon group, preferrably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

n and m represent 1;

L represents a divalent linking group;

a represents 0 or 1; and

and optionally one or more counter ions in order to obtain an electrically neutral compound.

In a highly preferred embodiment, the IR absorbing compound is represented by Formula V or Formula VI:

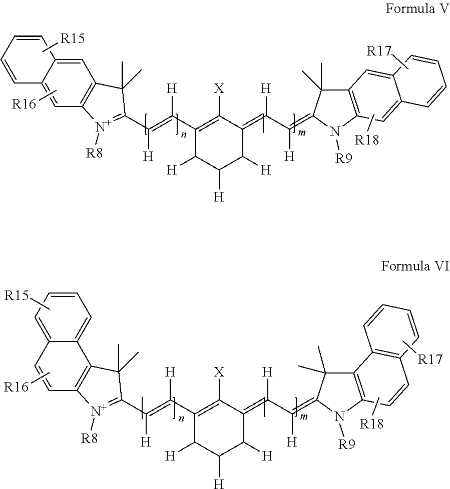

wherein

X represents hydrogen, a halogen atom, —SR11, —OR12, —NR13(LₐR14), an optionally substituted hydrocarbon group, preferably an optionally substituted (hetero)aryl group;

R11 and R12 independently represent an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

R8 and R9 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;

R15, R16, R17 and R18 independently represent hydrogen, a halogen atom, an alkoxy group or a nitrile;

R and R′ independently represent hydrogen or an alkyl group;

L represents a divalent linking group;

a represents 0 or 1; and

and optionally one or more counter ions in order to obtain an electrically neutral compound.

Preferably, the IR absorbing compound is represented by Formula V or Formula VI wherein:

R8 to R9, R, R′ and R15 to R18 are as defined above for Formula V or Formula VI;

X represents hydrogen, a halogen atom, —SR11, —NR13(LₐR14), an optionally substituted hydrocarbon group, preferably an optionally substituted (hetero)aryl group, more preferably an optionally substituted pyridine represented by Formula A;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

L represents a divalent linking group;

a represents 0 or 1; and

and optionally one or more counter ions in order to obtain an electrically neutral compound.

More preferably, the IR absorbing compound is represented by Formula V or Formula VI wherein:

R8 to R9, R, R′ and R15 to R18 are as defined above for Formula V or Formula VI;

X represents hydrogen, —SR11, —NR13(LₐR14), an optionally substituted hydrocarbon group, preferably an optionally substituted (hetero)aryl group, more preferably an optionally substituted pyridine represented by Formula A;

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring;

L represents a divalent linking group;

a represents 0 or 1; and

optionally one or more counter ions in order to obtain an electrically neutral compound.

Most preferably, the IR absorbing compound is represented by Formula V or Formula VI wherein:

R8 to R9, R, R′ and R15 to R18 are as defined above for Formula V or Formula VI;

X represents —SR11, —NR13(LₐR14),

R11 represents an optionally substituted hydrocarbon group, preferably an optionally substituted (hetero)aryl group;

R13 and R14 independently represent hydrogen, an optionally substituted hydrocarbon group, preferably an optionally substituted (hetero)aryl group;

R13 and R14 may comprise the necessary atoms to form a ring; L represents a divalent linking group;

a represents 0 or 1; and

and optionally one or more counter ions in order to obtain an electrically neutral compound.

The divalent linking group L preferably represents an optionally substituted alkylene, cycloalkylene, arylene, or heteroarylene, —O, —CO—, —CO—O—, —OCO—, —CO—NH—, —NH—CO—, —NH—CO—O—, —O—CO—NH, —NH—CO—NH—, —NH—CS—NH—, —CO—NR″—, —NH—CS—NH—, —SO—, —SO₂—, —SO₂—NH—, —NH—SO₂—, —CH═N—, —NH—NH—, —N+(CH₃)₂—, —S—, —S—S—, and/or combinations thereof, wherein R″ and R′″ each independently represent an optionally substituted alkyl, aryl, or heteroaryl group.

The infrared absorbing compounds described above preferably optionally contain one or more counter ions in order to obtain an electrically neutral compound

The IR dye can be a neutral, an anionic or a cationic dye depending on the type of the substituting groups and the number of each of the substituting groups. The dye may contain one anionic or acid group preferably present on R8 and/or R9, selected from —CO2H, —CONHSO2Rh, —SO2NHCORi, —SO2NHSO2Rj, —PO3H2, —OPO3H2, —OSO3H, —S—SO3H or —SO3H groups or their corresponding salts, wherein Rh, Ri and Rj independently represent an aryl or an alkyl group, preferably a methyl group, and wherein the salts are preferably alkali metal salts or ammonium salts, including mono- or di- or tri- or tetra-alkyl ammonium salts. Other optional substituting groups are defined above.

Suitable counter ions are for example an alkali metal cation such as e.g. Li⁺, Na⁺, K⁺; a halide anion, e.g. Cl⁻, Br⁻ or I⁻; a sulfonate group anion such as a alkyl or aryl sulfonate group anion; e.g. CH₃SO₃⁻, CF₃SO₃⁻ or p-toluene sulfonate; tetrafluoroborate; tetraphenylborate;

hexafluorophosphate or a perfluoroalkyl containing group.

The infrared absorbing compounds preferably have a major absorption maximum above 780 nm up to 1500 nm. The concentration of the IR-dyes with respect to the total dry weight of the coating, may be from 0.1 wt. % to 20.0 wt. %, more preferably from 0.5% wt to 15.0% wt, most preferred from 1.0 wt % to 10.0 wt %. According to the present invention, the amount of the infrared dye is preferably from 0.1 to 3% wt, more preferably from 0.2 to 1.5% wt and most preferably from 0.5 to 1% wt.

In a further highly preferred embodiment, the IR absorbing compound is represented by one of the following Formulae:

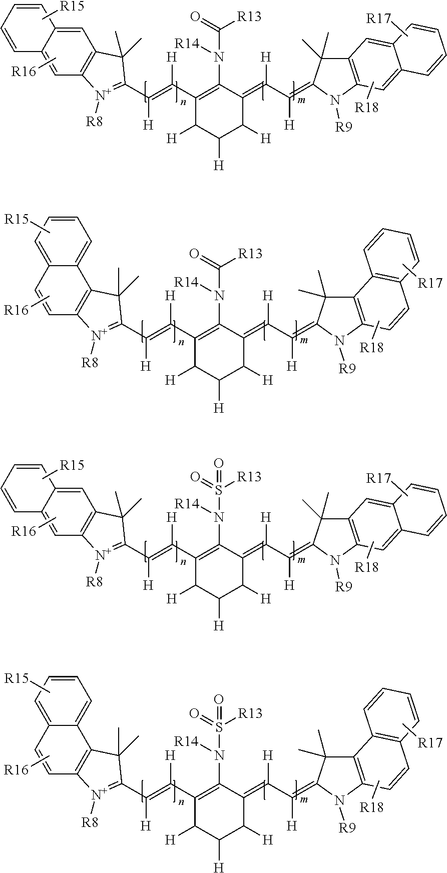

wherein

R13 and R14 independently represent hydrogen, an optionally substituted hydrocarbon group, preferably an optionally substituted (hetero)aryl group;

R8 and R9 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;

n and m independently represent an integer equal to zero, 1 or greater; preferably an integer equal to 0, 1, 2, 3, 4 or 5; most preferably equal to 1; R15, R16, R17 and R18 independently represent hydrogen, an amine group, a halogen atom, an alkoxy group or a nitrile;

and optionally one or more counter ions in order to obtain an electrically neutral compound.

In the Formulae above —NR13(LaR14) refers to the following chemical structure:

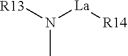

In a preferred embodiment, the divalent linking group L in this substituent —NR13(LₐR14), is not present and thus “a” represents 0. The substitutent then represents —NR13R14 without the divalent linking group L.

Without being limited thereto, especially preferred IR dyes used in the coating of the present invention are given below.

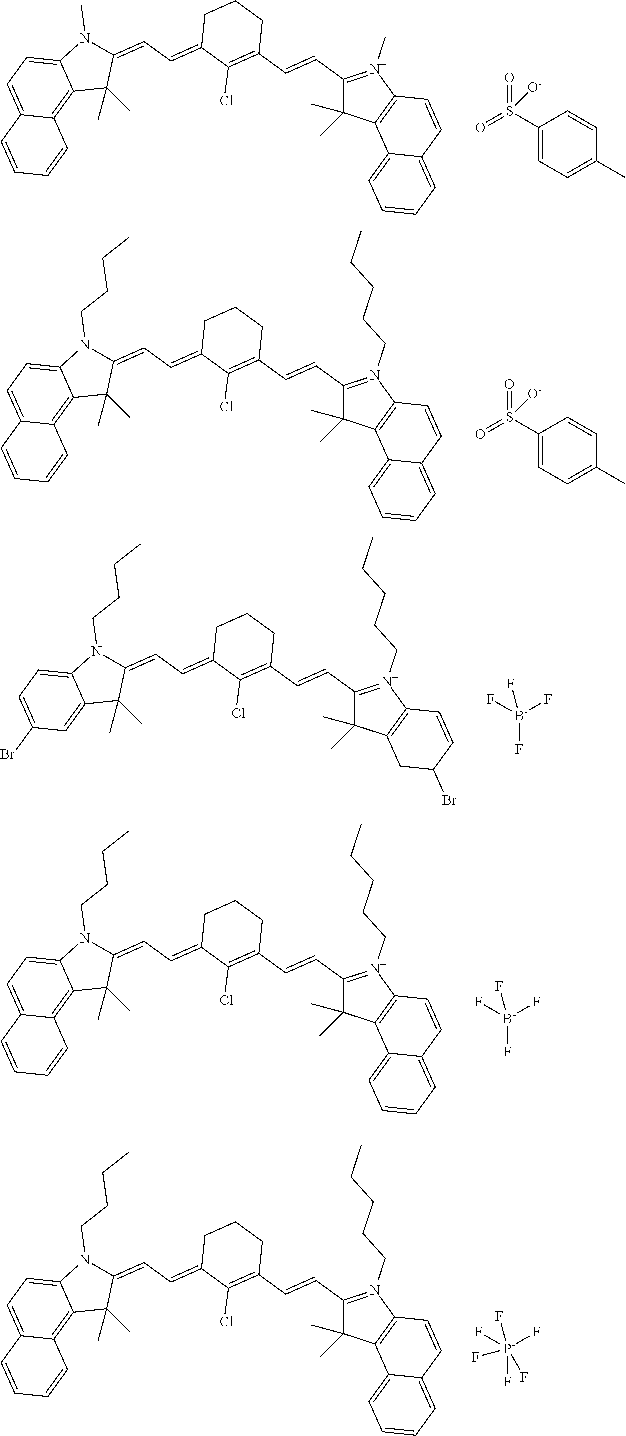

The Leuco Dye

All publicly-known leuco dyes can be used and are not restricted. They are for example widely used in conventional photosensitive or thermally-sensitive recording materials. For more information about leuco dyes, see for example Chemistry and Applications of Leuco Dyes, Ramaiah Muthyala, Plenum Press, 1997.

A number of classes of leuco dyes may be used as colour forming compounds in the present invention, such as for example: spiropyran leuco dyes such as spirobenzopyrans (e.g. spiroindolinobenzopyrans, spirobenzo-pyranobenzopyrans, 2,2-dialkylchromenes), spironaphtooxazine and spirothiopyran; leuco quinone dyes; azines such as oxazines, diazines, thiazines and phenazine; phthalide- and phthalimidine-type leuco dyes such as triarylmethane phtalides (e.g. crystal violet lactone), diarylmethane phthalides, monoarylmethane phthalides, heterocyclic substituted phthalides, alkenyl substituted phthalides, bridged phthalides (e.g. spirofluorene phthalides and spirobenzanthracene phthalides) and bisphthalides; fluoran leuco dyes such as fluoresceins, rhodamines and rhodols; triarylmethanes such as leuco crystal violet; ketazines; barbituric acid leuco dyes and thiobarbituric acid leuco dyes.

The leuco dye is preferably present in the toplayer in an amount of 0.01 to 0.1 g/m², more preferably in an amount of 0.02 to 0.08 g/m², most preferably in an amount of 0.025 to 0.05 g/m².

The following leuco dyes and/or reaction schemes are suitable to form a coloured dye upon exposure with heat and/or light.

Protonation of a Leuco Dye by an Acid Generator

The reaction scheme can be represented by:

leuco-dye+acid generator→leuco-dye+acid→coloured dye

All publicly-known photo- and thermal acid generators can be used in the present invention. They can optionally be combined with a photosensitizing dye. Photo- and thermal acid generators are for example widely used in conventional photoresist material. For more information see for example “Encyclopaedia of polymer science”, 4th edition, Wiley or “Industrial Photoinitiators, A Technical Guide”, CRC Press 2010.

Preferred classes of photo- and thermal acid generators are iodonium salts, sulfonium salts, ferrocenium salts, sulfonyl oximes, halomethyl triazines, halomethylarylsulfone, α-haloacetophenones, sulfonate esters, t-butyl esters, allyl substituted phenols, t-butyl carbonates, sulfate esters, phosphate esters and phosphonate esters.

Preferred leuco dyes used in combination with an acid generator include phthalide- and phthalimidine-type leuco dyes such as triarylmethane phtalides, diarylmethane phthalides, monoarylmethane phthalides, heterocyclic substituted phthalides, alkenyl substituted phthalides, bridged phthalides (e.g. spirofluorene phthalides and spirobenzanthracene phthalides) and bisphthalides; and fluoran Leuco Dyes such as fluoresceins, rhodamines and rhodols.

Especially preferred leuco dyes are heterocyclic substituted phthalides, alkenyl substituted phthalides, bridged phthalides (e.g. spirofluorene phthalides and spirobenzanthracene phthalides) and bisphthalides; and fluoran Leuco Dyes such as fluoresceins, rhodamines and rhodols.

Most preferred leuco dyes are fluoran Leuco Dyes such as fluoresceins, rhodamines and rhodols.

Oxidation of a Triarylmethane Leu Dye

The reaction scheme can be represented by:

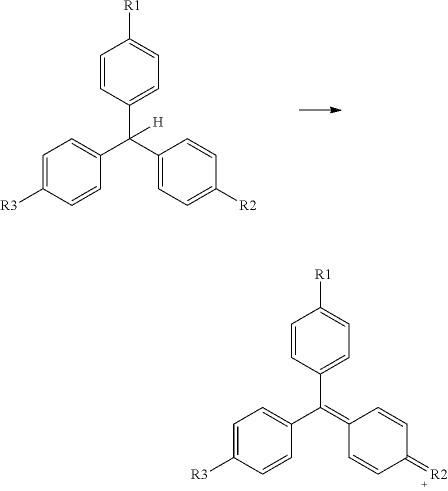

wherein R1, R2 and R3 each independently represent an amino group, an optionally substituted mono- or dialkylamino group, a hydroxyl group or an alkoxy group. R1 and R3 also each independently represent a hydrogen atom or an optionally substituted alkyl, aryl, or heteroaryl group. A preferred leuco dye for the present invention is leuco crystal violet (CASRN 603-48-5).

Oxidation of a Leu Quinone Dye

The reaction scheme can be represented by

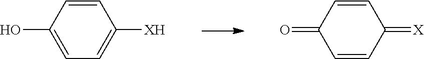

wherein X represents an oxygen atom or an optionally substituted amino or methine group.

The reaction scheme can be represented by:

leuco dye-FG→dye

wherein FG represents a fragmenting group.

Preferred such leuco dyes are oxazines, diazines, thiazines and phenazine. A particularly preferred leuco dye (CASRN104434-37-9) is shown in EP 174 054 which discloses a thermal imaging method for forming colour images by the irreversible unimolecular fragmentation of one or more thermally unstable carbamate moieties of an organic compound to give a visually discernible colour shift from colourless to coloured.

The fragmentation of a leuco dye may be catalyzed or amplified by acids, photo acid generators, and thermal acid generators.

Ring Opening of Spiropyran Leu Dyes

The reaction scheme can be represented by:

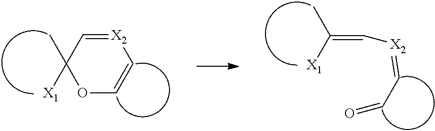

wherein X₁ represents an oxygen atom, an amino group, a sulphur atom or a selenium atom and X₂ represents an optionally substituted methine group or a nitrogen atom.

Preferred spiropyran leuco dyes are spiro-benzopyrans such as spiroindolinobenzopyrans, spirobenzopyranobenzopyrans, 2,2-dialkylchromenes; spironaphtooxazines and spirothiopyrans. In a particularly preferred embodiment, the spiropyran leuco dyes are CASRN 160451-52-5 or CASRN 393803-36-6. The ring opening of a spiropyran leuco dye may be catalyzed or amplified by acids, photo acid generators, and thermal acid generators.

The Lithographic Printing Plate Precursor

The lithographic printing plate precursor according to the present invention is negative-working, i.e. after exposure and development the non-exposed areas of the coating are removed from the support and define hydrophilic (non-printing) areas, whereas the exposed coating is not removed from the support and defines oleophilic (printing) areas. The hydrophilic areas are defined by the support which has a hydrophilic surface or is provided with a hydrophilic layer. The hydrophobic areas are defined by the coating, hardened upon exposing, optionally followed by a heating step. Areas having hydrophilic properties means areas having a higher affinity for an aqueous solution than for an oleophilic ink; areas having hydrophobic properties means areas having a higher affinity for an oleophilic ink than for an aqueous solution.

“Hardened” means that the coating becomes insoluble or non-dispersible for the developing solution and may be achieved through polymerization and/or crosslinking of the photosensitive coating, optionally followed by a heating step to enhance or to speed-up the polymerization and/or crosslinking reaction. In this optional heating step, hereinafter also referred to as “pre-heat”, the plate precursor is heated, preferably at a temperature of about 80° C. to 150° C. and preferably during a dwell time of about 5 seconds to 1 minute.

The coating has at least one layer including a photopolymerisable composition, said layer is also referred to as the “photopolymerisable layer”. The coating may include an intermediate layer, located between the support and the photopolymerisable layer. The lithographic printing precursors can be multi-layer imageable elements.

The printing plate of the present invention is characterized that it can be exposed at a low energy density, i.e. below 190 mJ/m²; preferably between 70 mJ/m² and 150 mJ/m²; more preferably between 75 mJ/m² and 120 mJ/m² and most preferably of maximum 80 mJ/m².

Support

The lithographic printing plate used in the present invention comprises a support which has a hydrophilic surface or which is provided with a hydrophilic layer. The support is preferably a grained and anodized aluminium support, well known in the art. Suitable supports are for example disclosed in EP 1 843 203 (paragraphs [0066] to [0075]). The surface roughness, obtained after the graining step, is often expressed as arithmetical mean center-line roughness Ra (ISO 4287/1 or DIN 4762) and may vary between 0.05 and 1.5 μm. The aluminum substrate of the current invention has preferably an Ra value below 0.45 μm, more preferably below 0.40 μm and most preferably below 0.30 μm. The lower limit of the Ra value is preferably about 0.1 μm. More details concerning the preferred Ra values of the surface of the grained and anodized aluminum support are described in EP 1 356 926. By anodising the aluminum support, an Al₂O₃ layer is formed and the anodic weight (g/m² Al₂O₃ formed on the aluminum surface) varies between 1 and 8 g/m². The anodic weight is preferably 3 g/m², more preferably 3.5 g/m² and most preferably 4.0 g/m²

The grained and anodized aluminium support may be subjected to so-called post-anodic treatments, for example a treatment with polyvinylphosphonic acid or derivatives thereof, a treatment with polyacrylic acid, a treatment with potassium fluorozirconate or a phosphate, a treatment with an alkali metal silicate, or combinations thereof. Alternatively, the support may be treated with an adhesion promoting compound such as those described in EP 1 788 434 in [0010] and in WO 2013/182328. However, for a precursor optimized to be used without a pre-heat step it is preferred to use a grained and anodized aluminium support without any post-anodic treatment.

Besides an aluminium support, a plastic support, for example a polyester support, provided with one or more hydrophilic layers as disclosed in for example EP 1 025 992 may also be used.

Photopolymer Coating

The coating has at least one layer including a photopolymerisable composition, said layer is also referred to as the “photopolymerisable layer”. The coating may include an intermediate layer, located between the support and the photopolymerisable layer.

The photopolymerisable layer includes besides the TBM-initiator, a leuco dye and the infrared absorbing compound as discussed above, a polymerisable compound and optionally a binder. The photopolymerisable layer has a coating thickness preferably ranging between 0.2 and 5.0 g/m², more preferably between 0.4 and 3.0 g/m², most preferably between 0.6 and 2.2 g/m².

According to a preferred embodiment of the present invention, the polymerisable compound is a polymerisable monomer or oligomer including at least one terminal ethylenic group, hereinafter also referred to as “free-radical polymerisable monomer”. The polymerisation involves the linking together of the free-radical polymerisable monomers.

Suitable free-radical polymerisable monomers are disclosed in [0042] and [0050] of EP 2 916 171 and are incorporated herein by reference.

Besides the TBM-initiator, the coating may optionally further contain any free radical initiator capable of generating free radicals upon exposure directly or in the presence of a sensitizer. Suitable free-radical initiators are described in WO 2005/111727 from page 15 line 17 to page 16 line 11 and EP 1 091 247 and may include for example hexaaryl-bisimidazole compound (HABI; dimer of triaryl-imidazole), aromatic ketones, aromatic onium salts, organic peroxides, thio compounds, ketooxime ester com-pounds, borate compounds, azinium compounds, metallocene compounds, active ester compounds and further compounds having a carbon-halogen bond.

The photopolymerisable layer may also comprise a co-initiator. Typically, a co-initiator is used in combination with a free radical initiator. Suitable co-initiators for use in the photopolymer coating are disclosed in U.S. Pat. Nos. 6,410,205; 5,049,479; EP 1 079 276, EP 1 369 232, EP 1 369 231, EP 1 341 040, US 2003/0124460, EP 1 241 002, EP 1 288 720 and in the reference book including the cited refences: Chemistry & Technology UV & EB formulation for coatings, inks & paints—Volume 3—Photoinitiators for Free Radical and Cationic Polymerisation by K.K. Dietliker—Edited by P.K.T. Oldring—1991—ISBN 0 947798161. Specific co-initiators, as described in EP 107 792, may be present in the photopolymerizable layer to further increase the sensitivity. Preferred co-initiators are disclosed in EP 2 916 171 [0051] and are incorporated herein by reference.

A very high sensitivity can be obtained by including a sensitizer such as for example an optical brightener in the coating. Suitable examples of optical brighteners as sensitizers are described in WO 2005/109103 page 24, line 20 to page 39. Other preferred sensitizers are blue, green or red light absorbing sensitizers, having an absorption spectrum between 450 nm and 750 nm. Useful sensitizers can be selected from the sensitizing dyes disclosed in U.S. Pat. Nos. 6,410,205; 5,049,479; EP 1 079 276, EP 1 369 232, EP 1 369 231, EP 1 341 040, US 2003/0124460, EP 1 241 002 and EP 1 288 720.

The photopolymerizable layer preferably includes a binder. The binder can be selected from a wide series of organic polymers. Compositions of different binders can also be used. Useful binders are described in WO2005/111727 page 17 line 21 to page 19 line 30, EP 1 043 627 in paragraph [0013] and in WO2005/029187 page 16 line 26 to page 18 line 11. Also suitable are particulate shaped polymers including homopolymers or copolymers prepared from monomers such as ethylene, styrene, vinyl chloride, methyl acrylate, ethyl acrylate, methyl methacrylate, ethyl methacrylate, acrylonitrile, vinyl carbazole, acrylate or methacrylate, or mixtures thereof.

Thermally reactive polymer fine particles including a thermally reactive group such as an ethylenically unsaturated group, a cationic polymerizable group, an isocyanate group, an epoxy group, a vinyloxy group, and a functional group having an active hydrogen atom, a carboxy group, a hydroxy group, an amino group or an acid anhydride, may be included in the coating.

The average particle diameter of the polymer fine particle is preferably 0.01 mm to 3.0 mm. Particulate polymers in the form of microcapsules, microgels or reactive microgels are suitable as disclosed in EP 1 132 200; EP 1 724 112; US 2004/106060.

The photopolymerisable layer may also comprise particles which increase the resistance of the coating against manual or mechanical damage. The particles may be inorganic particles, organic particles or fillers such as described in for example U.S. Pat. No. 7,108,956. More details of suitable spacer particles described in EP 2 916 171 [0053] to [0056] are incorporated herein by reference.

The photopolymerizable layer may also comprise an inhibitor. Particular inhibitors for use in the photopolymer coating are disclosed in U.S. Pat. No. 6,410,205, EP 1 288 720 and EP 1 749 240.

The photopolymerizable layer may further comprise an adhesion promoting compound. The adhesion promoting compound is a compound capable of interacting with the support, preferably a compound having an addition-polymerizable ethylenically unsaturated bond and a functional group capable of interacting with the support. Under “interacting” is understood each type of physical and/or chemical reaction or process whereby, between the functional group and the support, a bond is formed which can be a covalent bond, an ionic bond, a complex bond, a coordinate bond or a hydrogen-bond, and which can be formed by an adsorption process, a chemical reaction, an acid-base reaction, a complex-forming reaction or a reaction of a chelating group or a ligand. The adhesion promoting compounds described in EP 2 916 171 [0058] are incorporated herein by reference.

Various surfactants may be added into the photopolymerisable layer to allow or enhance the developability of the precursor; especially developing with a gum solution. Both polymeric and small molecule surfactants for example nonionic surfactants are preferred. More details are described in EP 2 916 171 [0059] and are incorporated herein by reference.

The coating may include on the photopolymerisable layer, a toplayer or protective overcoat layer which acts as an oxygen barrier layer including water-soluble or water-swellable binders. Printing plate precursors which do not contain a toplayer or protective overcoat layer are also referred to as overcoat-free printing plate precursors. In the art, it is well-known that low molecular weight substances present in the air may deteriorate or even inhibit image formation and therefore usually a toplayer is applied to the coating. A toplayer should be easily removable during development, adhere sufficiently to the photopolymerisable layer or optional other layers of the coating and should preferably not inhibit the transmission of light during exposure. Preferred binders which can be used in the toplayer are polyvinyl alcohol and the polymers disclosed in WO 2005/029190; U.S. Pat. No. 6,410,205 and EP 1 288 720, including the cited references in these patents and patent applications. The most preferred binder for the toplayer is polyvinylalcohol. The polyvinylalcohol has preferably a hydrolysis degree ranging between 74 mol % and 99 mol %, more preferably between 88-98%. The weight average molecular weight of the polyvinylalcohol can be measured by the viscosity of an aqueous solution, 4% by weight, at 20° C. as defined in DIN 53 015, and this viscosity number ranges preferably between 2 and 26, more preferably between 2 and 15, most preferably between 2 and 10.

The protective overcoat layer may optionally include other ingredients such as inorganic or organic acids, matting agents or wetting agents as disclosed in EP 2 916 171 and are incorporated herein by reference.

The coating thickness of the optional toplayer is preferably between 0.25 and 1.75 g/m², more preferably between 0.25 and 1.3 g/m², most preferably between 0.25 and 1.0 g/m². In a more preferred embodiment of the present invention, the optional toplayer has a coating thickness between 0.25 and 1.75 g/m² and comprises a polyvinylalcohol having a hydrolysis degree ranging between 74 mol % and 99 mol % and a viscosity number as defined above ranging between 3 and 26.

According to the present invention there is also provided a method for making a negative-working lithographic printing plate comprising the steps of imagewise exposing a printing plate precursor followed by developing the imagewise exposed precursor so that the non-exposed areas are dissolved in the developer solution. Optionally, after the imaging step, a heating step is carried out to enhance or to speed-up the polymerization and/or crosslinking reaction. The lithographic printing plate precursor can be prepared by (i) applying on a support the coating as described above and (ii) drying the precursor.

Exposure Step

The printing plate precursor is preferably image-wise exposed by a laser emitting IR-light. Preferably, the image-wise exposing step is carried out off-press in a platesetter, i.e. an exposure apparatus suitable for image-wise exposing the precursor with a laser such as a laser diode, emitting around 830 nm or a Nd YAG laser emitting around 1060 nm, or by a conventional exposure in contact with a mask. In a preferred embodiment of the present invention, the precursor is image-wise exposed by a laser emitting IR-light.

Preheat Step

After the exposing step, the precursor may be pre-heated in a preheating unit, preferably at a temperature of about 80° C. to 150° C. and preferably during a dwell time of about 5 seconds to 1 minute. This preheating unit may comprise a heating element, preferably an IR-lamp, an UV-lamp, heated air or a heated roll. Such a preheat step can be used for printing plate precursors comprising a photopolymerisable composition to enhance or to speed-up the polymerization and/or crosslinking reaction.

Development Step

Subsequently to the exposing step or the preheat step, when a preheat step is present, the plate precursor may be processed (developed). Before developing the imaged precursor, a pre-rinse step might be carried out especially for the negative-working lithographic printing precursors having a protective oxygen barrier or topcoat. This pre-rinse step can be carried out in a stand-alone apparatus or by manually rinsing the imaged precursor with water or the pre-rinse step can be carried out in a washing unit that is integrated in a processor used for developing the imaged precursor. The washing liquid is preferably water, more preferably tap water. More details concerning the wash step are described in EP 1 788 434 in [0026].

During the development step, the non-exposed areas of the image-recording layer are at least partially removed without essentially removing the exposed areas. The processing liquid, also referred to as developer, can be applied to the plate e.g. by rubbing with an impregnated pad, by dipping, immersing, coating, spincoating, spraying, pouring-on, either by hand or in an automatic processing apparatus. The treatment with a processing liquid may be combined with mechanical rubbing, e.g. by a rotating brush. During the development step, any water-soluble protective layer present is preferably also removed. The development is preferably carried out at temperatures between 20 and 40° C. in automated processing units.

In a highly preferred embodiment, the processing step as described above is replaced by an on-press processing whereby the imaged precursor is mounted on a press and processed on-press by rotating said plate cylinder while feeding dampening liquid and/or ink to the coating of the precursor to remove the unexposed areas from the support. In a preferred embodiment, only dampening liquid is supplied to the plate during start-up of the press. After a number of revolutions of the plate cylinder, preferably less than 50 and most preferably less than 5 revolutions, also the ink supply is switched on. In an alternative embodiment, supply of dampening liquid and ink can be started simultaneously or only ink can be supplied during a number of revolutions before switching on the supply of dampening liquid.

The processing step may also be performed by combining embodiments described above, e.g. combining development with a processing liquid with development on-press by applying ink and/or fountain.

Processing Liquid

The processing liquid may be an alkaline developer or solvent-based developer. Suitable alkaline developers have been described in US200510162505. An alkaline developer is an aqueous solution which has a pH of at least 11, more typically at least 12, preferably from 12 to 14. Alkaline developers typically contain alkaline agents to obtain high pH values can be inorganic or organic alkaline agents. The developers can comprise anionic, non-ionic and amphoteric surfactants (up to 3% on the total composition weight); biocides (antimicrobial and/or antifungal agents), antifoaming agents or chelating agents (such as alkali gluconates), and thickening agents (water soluble or water dispersible polyhydroxy compounds such as glycerine or polyethylene glycol).

Preferably, the processing liquid is a gum solution whereby during the development step the non-exposed areas of the photopolymerisable layer are removed from the support and the plate is gummed in a single step. The development with a gum solution has the additional benefit that, due to the remaining gum on the plate in the non-exposed areas, an additional gumming step is not required to protect the surface of the support in the non-printing areas. As a result, the precursor is processed and gummed in one single step which involves a less complex developing apparatus than a developing apparatus comprising a developer tank, a rinsing section and a gumming section. The gumming section may comprise at least one gumming unit or may comprise two or more gumming units. These gumming units may have the configuration of a cascade system, i.e. the gum solution, used in the second gumming unit and present in the second tank, overflows from the second tank to the first tank when gum replenishing solution is added in the second gumming unit or when the gum solution in the second gumming unit is used once-only, i.e. only starting gum solution is used to develop the precursor in this second gumming unit by preferably a spraying or jetting technique. More details concerning such gum development is described in EP1 788 444.

A gum solution is typically an aqueous liquid which comprises one or more surface protective compounds that are capable of protecting the lithographic image of a printing plate against contamination, e.g. by oxidation, fingerprints, fats, oils or dust, or damaging, e.g. by scratches during handling of the plate. Suitable examples of such surface protective compounds are film-forming hydrophilic polymers or surfactants. The layer that remains on the plate after treatment with the gum solution preferably comprises between 0.005 and 20 g/m² of the surface protective compound, more preferably between 0.010 and 10 g/m², most preferably between 0.020 and 5 g/m². More details concerning the surface protective compounds in the gum solution can be found in WO 2007/057348 page 9 line 3 to page 11 line 6. As the developed plate precursor is developed and gummed in one step, there is no need to post-treat the processed plate.

The gum solution preferably has a pH value between 3 and 11, more preferably between 4 and 10, even more preferably between 5 and 9, and most preferably between 6 and 8. A suitable gum solution is described in for example EP 1 342 568 in [0008] to [0022] and WO2005/111727. The gum solution may further comprise an inorganic salt, an anionic surfactant, a wetting agent, a chelate compound, an antiseptic compound, an anti-foaming compound and/or an ink receptivity agent and/or combinations thereof. More details about these additional ingredients are described in WO 2007/057348 page 11 line 22 to page 14 line 19.

Drying and Baking Step

After the processing step the plate may be dried in a drying unit. In a preferred embodiment the plate is dried by heating the plate in the drying unit which may contain at least one heating element selected from an IR-lamp, an UV-lamp, a heated metal roller or heated air.

After drying the plate can optionally be heated in a baking unit. More details concerning the heating in a baking unit can be found in WO 2007/057348 page 44 line 26 to page 45 line 20.

The printing plate thus obtained can be used for conventional, so-called wet offset printing, in which ink and an aqueous dampening liquid is supplied to the plate. Another suitable printing method uses a so-called single-fluid ink without a dampening liquid. Suitable single-fluid inks have been described in U.S. Pat. Nos. 4,045,232; 4,981,517 and 6,140,392. In a most preferred embodiment, the single-fluid ink comprises an ink phase, also called the hydrophobic or oleophilic phase, and a polyol phase as described in WO 00/32705.

### EXAMPLES

1. Preparation of the comparative printing plate precursors PP-01, PP-02 and PP-05, and inventive printing plate precursors PP-03, PP-04 and PP-06.

Preparation of the Aluminium Support S-01

A 0.3 mm thick aluminium foil was degreased by spraying with an aqueous solution containing 26 g/l NaOH at 65° C. for 2 seconds and rinsed with demineralised water for 1.5 seconds. The foil was then electrochemically grained during 10 seconds using an alternating current in an aqueous solution containing 15 g/l HCl, 15 g/l SO₄²⁻ ions and 5 g/l Al³⁺ ions at a temperature of 37° C. and a current density of about 100 A/dm². Afterwards, the aluminium foil was then desmutted by etching with an aqueous solution containing 5.5 g/l of NaOH at 36° C. for 2 seconds and rinsed with demineralised water for 2 seconds. The foil was subsequently subjected to anodic oxidation during 15 seconds in an aqueous solution containing 145 g/l of sulfuric acid at a temperature of 50° C. and a current density of 17 A/dm², then washed with demineralised water for 11 seconds and dried at 120° C. for 5 seconds.

The support thus obtained was characterized by a surface roughness Ra of 0.35-0.4 μm (measured with interferometer NT1100) and had an oxide weight of 3.0 g/m².

Photopolymerisable Layer

The printing plate precursor PPP-01 to PPP-06 were prepared by first coating onto the above described support S-01 the photosensitive compositions as defined in Table 1. The components were dissolved in a mixture of 35% by volume of MEK and 65% by volume of Dowanol PM (1-methoxy-2-propanol, commercially available from DOW CHEMICAL Company). The coating solution was applied at a wet coating thickness of 30 μm and then dried at 120° C. for 1 minute in a circulation oven.

TABLE 1
Composition of the photosensitive layers PL-01 to PL-06

| INGREDIENT | | | | | | |
|---|---|---|---|---|---|---|
| mg/m² | PL-01 | PL-02 | PL-03 | PL-04 | PL-05 | PL-06 |
| IR dye-01 (1) | 22 | | | | | |
| IR dye-02 (1) | | 22 | | | | |
| IR dye-03 (1) | | | 22 | | 22 | 22 |
| IR dye-04 (1) | | | | 22 | | |
| Binder (2) | 150 | 150 | 150 | 150 | 150 | 150 |
| FST 150 (3) | 280 | 280 | 280 | 280 | 280 | 280 |
| CN-UVE151M (4) | 290 | 290 | 290 | 290 | 290 | 290 |
| Ini-01 (5) | | | | | 60 | |
| Ini-02 (5) | 60 | 60 | 60 | 60 | | 60 |
| Leuco-01 (6) | 50 | 50 | 50 | 50 | 50 | |
| Leuco-02 (6) | | | | | | 50 |
| Tegoglide 410 (7) | 1.5 | 1.5 | 1.5 | 1.5 | 1.5 | 1.5 |
| Sipomer PAM 100 (8) | 130 | 130 | 130 | 130 | 130 | 130 |
| Albritect CP 30 (9) | 24 | 24 | 24 | 24 | 24 | 24 |

1. IR dye-01 is an infrared absorbing dye commercially available from FEW Chemicals as S2025 having the following structure:

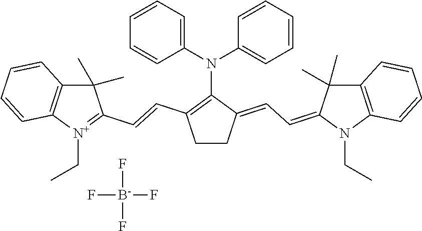 [SMILES: CCN1/C(=C/C=C2\CCC(/C=C/C3=[N+](CC)c4ccccc4C3(C)C)=C2N(c2ccccc2)c2ccccc2)C(C)(C)c2ccccc21 ; F[B-](F)(F)F]

IR dye-02 is an infrared absorbing dye commercially available from FEW Chemicals as S2539 having the following structure:

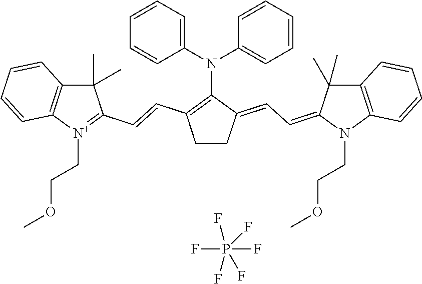

IR dye-03 is an infrared absorbing dye commercially available from Hampford Research Inc. as IR Dye 813 having the following structure:

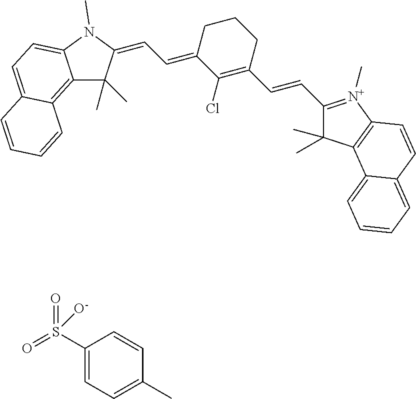 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1]

IR dye-04 is an infrared absorbing dye commercially available from FEW chemicals as S0750 having the following structure:

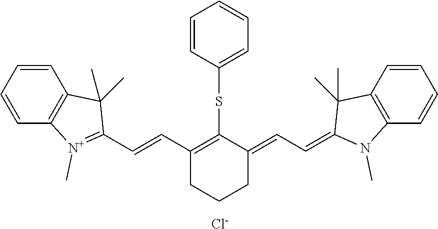 [SMILES: CN1/C(=C/C=C2\CCCC(/C=C/C3=[N+](C)c4ccccc4C3(C)C)=C2Sc2ccccc2)C(C)(C)c2ccccc21 ; [Cl-]]

2. Binder-01 represents S-LEC BX35Z, a polyvinyl butyral commercially available from Sekisui;
3. FST 510 is a reaction product from 1 mole of 2,2,4-trimethylhexamethylenediisocyanate and 2 moles of hydroxyethyl-methacrylate commercially available from AZ Electronics as a 82 wt. % solution in MEK;
4. CN-UVE 151M is an epoxy diacrylate monomer commercially available from Sartomer Ebecryl 220 is a hexafunctional aromatic urethane acrylate commercially available from Allnex Belgium;
5. Ini-01 is Bis(4-tert-butyl phenyl) iodonium tetraphenylborate is an onium initiator commercially available from AZ electronics; Ini-02 is is p-OH-TBMPS 4-hydroxyphenyl-tribromomethyl-sulfone;
6. Leuco-01 is Yamamoto red 40, a magenta colored leuco dye from Mitsui having the following structure:

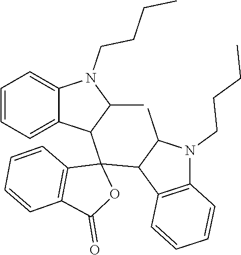 [SMILES: CCCCN1c2ccccc2C(C2(C3c4ccccc4N(CCCC)C3C)OC(=O)c3ccccc32)C1C]

Leuco-02 is Black XV, a 6-diethylamino-3-methyl-2-(2,4-xylidino) fluoran from Mitsui having the following structure:

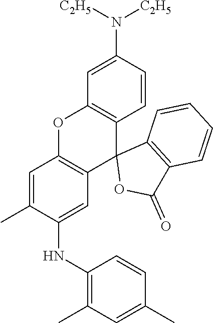 [SMILES: CCN(CC)c1ccc2c(c1)Oc1cc(C)c(Nc3ccc(C)cc3C)cc1C21OC(=O)c2ccccc21]

7. Tegoglide 410 is a surfactant commercially available from Evonik Tego Chemie GmbH;
8. Sipomer PAM 100 is a methacrylate phosphonic ester commercially available from Rhodia;
9. Albritect CP 30 is a polyacrylic acid-c-polyvinylphosphonic acid commercially available from Rhodia.

Protective Overcoat Layer

On top of the photosensitive layer, a solution in water with the composition as defined in Table 2 was coated (40 μm) on the printing plate precursors, and dried at 110° C. for 2 minutes.

TABLE 2
composition of the protective overcoat layer

| INGREDIENT | |
|---|---|
| g | OC-01 |
| Mowiol 4-88 (1) | 15.1 |
| Mowiol 4-98 (1) | 9.1 |
| Lutensol A8 (2) | 0.27 |
| Water | 975 |

(1) Mowiol 4-88TM is a partially hydrolyzed polyvinylalcohol and Mowiol 4-98TM is a fully hydrolyzed polyvinylalcohol, both commercially available from Kuraray;
(2) Lutensol A8TM is a surface active agent commercially available from BASF.

Printing plate precursors PPP-01 to PPP-06 were obtained and are summarized in Table 3.

TABLE 3
Lithographic printing plate precursors PPP-01 to PPP-06

| Printing plate | Photopolymerizable | Protective |
|---|---|---|
| precursor | layer | layer |
| PPP-1 | PL-1 | OC-1 |
| Comparative | | |
| PPP-2 | PL-2 | OC-1 |
| Comparative | | |
| PPP-3 | PL-3 | OC-1 |
| Inventive | | |
| PPP-4 | PL-4 | OC-1 |
| Inventive | | |
| PPP-5 | PL-5 | OC-1 |
| Comparative | | |
| PPP-6 | PL-6 | OC-1 |
| Inventive | | |

2. Imaging

The printing plate precursors PPP-1 to PPP-6 were imaged at 2400 dpi with a High Power Creo 40W TE38 thermal platesetter (200 Ipi Agfa Balanced Screening (ABS)), commercially available from Kodak and equipped with a 830 nm IR laser diode, at energy densities between 60 and 120 mJ/cm2.

3. Results

ΔE Measurement

Lab measurement executed with a GretagMacBeth SpectroEye reflection spectrophotometer with the settings: D50 (illuminant), 2° (Observer), No filter; commercially available from GretagMacBeth. The total colour difference ΔE is a single value that takes into account the difference between the L, a* and b* values of the image areas and the non-image areas:

ΔE=\sqrt{ΔL²+Δa²+Δb²}

The higher the total colour difference ΔE, the better the obtained contrast.

The contrast between image and non-image areas results in the occurrence of a print-out image.

Effect of Office Light Exposure on the Contrast

After the exposure step described above, the printing plate precursors PPP-01 to PPP-04 and PPP-06 were exposed to office light (900 lux) for a period of one to six hours. The results of the obtained ΔE measurements are summarised in Table 4.

TABLE 4
Effect of office light exposure on the contrast

| Office light | PPP-01 | PPP-02 | PPP-03 | PPP-04 | PPP-05 | PPP-06 |
|---|---|---|---|---|---|---|
| 900 lux | Comp | Comp | Inventive | inventive | Comp | inventive |
| Exposure time | ΔE* | | | | | |
| Hours | | | | | | |
| 0 (fresh) | 4.2 | 4.5 | 4.8 | 2.0 | 5.0 | 2.5 |
| 1 | 3.2 | 3.8 | 4.8 | 2.1 | 1.2 | 2.1 |
| 2 | 2.7 | 3.5 | 4.9 | 2.4 | 0.8 | 2.0 |
| 4 | 2.2 | 3.2 | 6.3 | 2.8 | 0.7 | 2.4 |
| 6 | 2.2 | 3.3 | 7.5 | 2.7 | 1.0 | 2.7 |

*see above

The results summarized in Table 4 show that:
the contrast in terms of the ΔE value of the inventive printing plates PP-03, PP-04 and PP-06 including an IR dye according to the current invention containing a central six membered ring remains stable and/or increases after exposure to office light;
the contrast in terms of the ΔE value of the comparative printing plates PP-01 and PP-02 including an IR dye containing a central five membered ring declines after exposure to office light;
the contrast in terms of the ΔE value of the comparative printing plate PPP-05 including a iodonium based initiator drastically declines after exposure to office light.

1-15. (canceled)

16. A method for making a lithographic printing plate including the steps of
image-wise exposing a printing plate precursor—including a support and a coating comprising a polymerisable compound, a leuco dye, an infrared absorbing compound and an optionally substituted trihaloalkyl sulfone initiator—to heat and/or IR radiation whereby a lithographic image consisting of image areas and non-image areas is formed and whereby a color change in the image areas is induced;
developing the exposed precursor by mounting the precursor on a plate cylinder of a lithographic printing press and rotating the plate cylinder while feeding dampening liquid and/or ink to the precursor,
characterized in that the infrared absorbing compound has a structure according to the following Formula I: 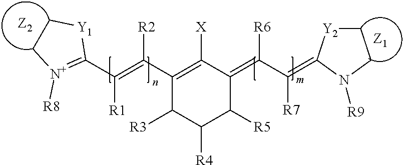
wherein,
R1, R2, R6, and R7 each independently represent hydrogen or an optionally substituted hydrocarbon group;
R3, R4, and R5 each independently represent hydrogen, an optionally substituted hydrocarbon group, a halogen atom, an optionally substituted alkoxy group, an optionally substituted aryloxy group, an amino group, a carbonyl containing group, or a silyl group such as for example trimethylsilyl;
X represents hydrogen, a halogen atom, —SR11, —OR12, —NR13(LₐR14), an optionally substituted hydrocarbon group, preferably an optionally substituted (hetero)aryl group;
L represents a divalent linking group;
a represents 0 or 1;
R11 and R12 each independently represent an optionally substituted hydrocarbon group, preferably an optionally substituted (hetero)aryl group;
R13 and R14 each independently represent hydrogen, an optionally substituted hydrocarbon group, preferably an optionally substituted (hetero)aryl group;
R13 and R14 may comprise the necessary atoms to form a ring;
Y1 and Y2 each independently represents —N(R10)-, —S—, —O—, —CH═CH—, or a dialkylmethylene group,
R8, R9, and R10 each independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;
Z1 and Z2 each independently represent an optionally substituted aryl or heteroaryl group;
n and m each independently represent an integer equal to zero, 1 or greater; and optionally one or more counter ions in order to obtain an electrically neutral compound.

17. The method according to claim 16, wherein the infrared absorbing compound has a structure according to Formula II: 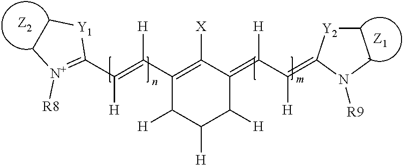
wherein X, R8, R9, Y1, Y2, Z1, Z2, m, and n are as defined in claim 16; and Formula II may include one or more counter ions in order to obtain an electrically neutral compound.

18. The method according to claim 16, wherein the infrared absorbing compound has a structure according to Formula III or Formula IV: 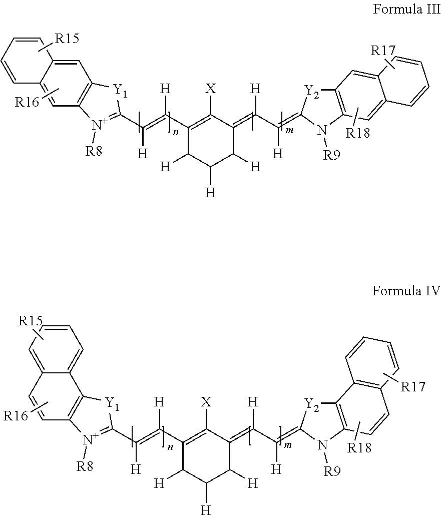
wherein
Y1, Y2, R8, R9, X, n, and m are as defined in claim 16;
R15, R16, R17, and R18 each independently represent hydrogen, an amine group, a halogen atom, an alkoxy group or a nitrile;
and Formula III and Formula IV may include one or more counter ions in order to obtain an electrically neutral compound.

19. The method according to claim 18, wherein the infrared absorbing compound has a structure according to Formula V or Formula VI: 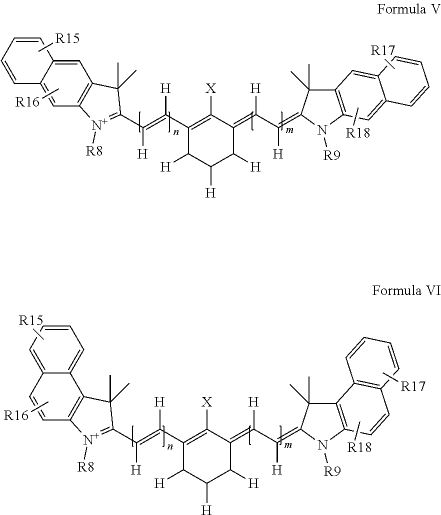
wherein
R8, R9, X, n, m, and R15 to R18 are as defined in claim 18;
and optionally one or more counter ions in order to obtain an electrically neutral compound.

20. The method according to claim 16, wherein
X represents hydrogen, a halogen atom, —SR11, —NR13(LaR14), or an optionally substituted hydrocarbon group;
R11 represents hydrogen, an optionally substituted hydrocarbon group, preferably an optionally substituted (hetero)aryl group;
R13 and R14 each independently represent hydrogen, an optionally substituted hydrocarbon group, preferably an optionally substituted (hetero)aryl group;
R13 and R14 may comprise the necessary atoms to form a ring;
L represents a divalent linking group;
a represents 0 or 1;
and optionally one or more counter ions in order to obtain an electrically neutral compound.

21. The method according to claim 20, wherein X represents an optionally substituted pyridine represented by Formula A: 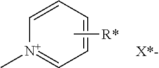
wherein
X*—represents a counter ion to neutralize electric charge;
R* represents hydrogen, an alkyl group, an alkoxy group, an aryl group, an amino group or a halogen atom.

22. The method according to claim 16, wherein the infrared absorbing compound is represented by the following Formulae: 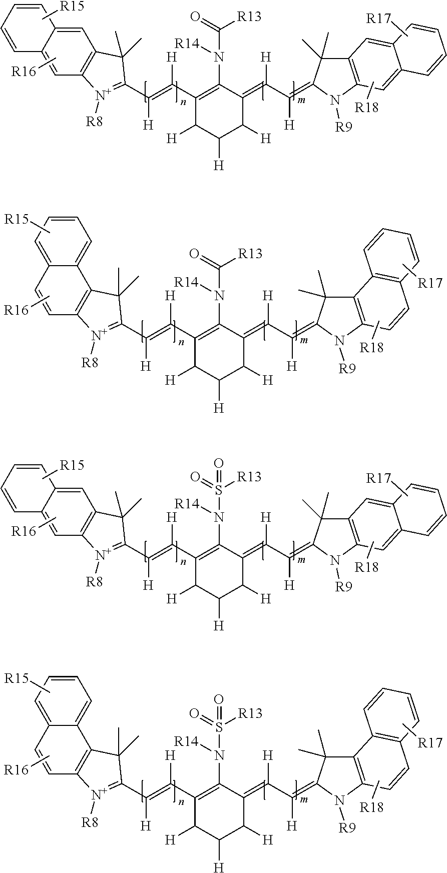
wherein
R13 and R14 independently represent hydrogen, an optionally substituted hydrocarbon group, preferably an optionally substituted (hetero)aryl group;
R8 and R9 independently represent an optionally substituted alkyl group, an optionally substituted alkoxy group, an optionally substituted hydrocarbon group, an optionally substituted carbonyl containing group, an optionally substituted polyalkylene-oxide group and/or combinations thereof;
n and m independently represent an integer equal to zero, 1 or greater; R15, R16, R17 and R18 independently represent hydrogen, an amine group, a halogen atom, an alkoxy group or a nitrile;
and optionally one or more counter ions in order to obtain an electrically neutral compound.

23. The method according to claim 16, wherein a represents zero.

24. The method according to claim 16, wherein n and m represent 1.

25. The method according to claim 16, wherein the leuco dye is selected from heterocyclic substituted phthalides and fluoran Leuco dyes.

26. The method according to claim 25, wherein the leuco dye is selected from fluoresceins, rhodamines and rhodols.

27. The method according to claim 16, wherein the color change characterized by a CIE 1976 color distance ΔE of the image areas remains stable or increase after exposure to office light.

28. The method according to claim 16, wherein the energy density of the IR radiation is comprised between 70 mJ/m² and 150 mJ/m².

29. The method according to claim 21, wherein a represents zero.

30. The method according to claim 21, wherein n and m represent 1.

31. The method according to claim 22, wherein the leuco dye is selected from heterocyclic substituted phthalides and fluoran Leuco dyes.

32. The method according to claim 31, wherein the leuco dye is selected from fluoresceins, rhodamines and rhodols.

33. The method according to claim 22, wherein the color change characterized by a CIE 1976 color distance ΔE of the image areas remains stable or increase after exposure to office light.

34. The method according to claim 22, wherein the energy density of the IR radiation is comprised between 70 mJ/m² and 150 mJ/m².
